(19) United States
(12) Patent Application Publication
(10) Pub. No.: US 2001/0044664 A1
(43) Pub. Date: Nov. 22, 2001

(54) Device for playing back multimedia data files from a storage device in an automotive sound system

(76) Inventors: Thomas Mueller, Hannover (DE); Matthias Wanschura, Hannover (DE); Torsten Mlasko, Pattensen (DE); Volker Lauke, Hohenhameln (DE)

Correspondence Address: KENYON & KENYON, ONE BROADWAY, NEW YORK, NY, 10004, US

(21) Appl. No.: 09/816,526

(22) Filed: Mar. 23, 2001

(30) Foreign Application Priority Data
Mar. 25, 2000 (DE) 100 14 987.1-21

(51) Int. Cl. G06F 17/00; H04B 1/00

(52) U.S. Cl. 700/94; 381/86

(57) ABSTRACT

A device is proposed for playing back multimedia data files from a storage device in an automotive sound system, the device being used to display directories and multimedia data files, located on the storage device, as data carriers and titles, respectively. This permits an intuitive operation of an automotive sound system. The individual data carriers and titles are selected using a rocker which is operable both in the vertical and in the horizontal direction. If data carriers and/or titles are displayed, and if after a predefined time no input takes place, titles are automatically displayed and played back. So-called play lists can be created. After inserting a storage device into a disk drive, the first multimedia data file having the first title in the first data carrier is automatically decoded and played back with the aid of a loudspeaker. The playback of titles in random sequence is made possible using the input apparatus 8. The multimedia data files are coded in MP3.

### FIELD OF THE INVENTION

The present invention relates to a device for playing back multimedia data files from a storage device in an automotive sound system.

### BACKGROUND INFORMATION

MP3 playback devices already exist which have a hard disk to which audio data files are transferred by a data transfer from a computer, to then be played back by the MP3 playback device. These MP3 playback devices have a display which supplies different information about the played-back music. Several hundred pieces of music can be stored on MP3 data carriers.

### SUMMARY OF THE INVENTION

In contrast, the device of the present invention for playing back multimedia data files from a storage device in an automotive sound system has the advantage that interchangeable storage media exist, and that an intuitive selection aid is implemented for selecting a title, which given an extensive supply of audio data files, as is possible in the case of MP3, is desirable in order to permit easy operation. The device of the present invention is part of an automotive sound system, various elements of the automotive sound system being used for the device according to the present invention, resulting in profit from a synergistic effect.

It is particularly advantageous that existing data structures are translated into an operating philosophy modeled on the CD changer. In this context, virtual data carriers are assigned to the individual directories in which the multimedia data files are located; for example, CD 1 is assigned to directory 1, and the titles or numbers of the multimedia data files are assigned to the multimedia files contained therein. This results in markedly simplified operation which is very useful, particularly for an automobile driver, since he/she is not distracted by a complicated operation.

It is advantageous that the device of the present invention makes it possible to link multimedia data files to at least one new directory or even to store again in the new directory. This permits the creation of so-called Play Lists, which is of particular advantage if a large number of music selections are present on the storage device, since they then represent an individually assembled collection of music selections which can be called up as desired. The operating control elements of the input device advantageously allow the management of the play lists, to which belong the sorting, deletion and selection of titles.

It is particularly advantageous that both the data carriers and the titles on the storage device are selected using a rocker. This greatly simplifies the operation of the device according to the present invention, particularly in the automobile, and the driver is not distracted from his/her driving activity.

Another advantage is that when a data carrier, thus a directory, has been selected, after a predefined first time, a switch is made automatically to the first title of the first data file located in this selected directory, and then this multimedia data file is immediately played back. This permits a multimedia data file of a data carrier selected by a driver to be played back the driver by a simple selection of a data carrier.

Of further advantage is that, when a storage device, thus a CD ROM, a DVD, a minidisk, a hard disk or a chip card, is inserted into the disk drive, the first title is played back immediately, and the driver is therefore freed from a further operation for playing back music or other multimedia data. This simplifies the operation of the device according to the present invention considerably.

It is also advantageous that if a title or other information such as the Interpret is available in the multimedia data file, this information is displayed, and if not, that the name of the multimedia data file or a number, e.g. a track number, is displayed. This permits the easy identification of the played-back multimedia data file.

Another advantage is that the device of the present convention makes it possible to play back a random sequence of multimedia data files of a data carrier or of the entire storage device. This further development offers the advantage to the driver that the various titles of the storage device are played back, without an input by him/her being expected.

Of advantage, moreover, is that the device of the present invention, with the aid of an input signal, permits the start of play of the titles of one data carrier or of the entire storage device, in order to provide the driver with an overview of the available music.

Furthermore, it is advantageous that the interchangeable storage device is designed as a CD ROM, a DVD, a hard disk, a minidisk, or as a chip card. These are standard formats for data carriers.

Finally, it is of advantage that the data stored on the storage device are stored as MP3 data files, and thus profit from the efficient storage through the MP3 coding. Consequently, a large number of music selections can advantageously be stored on one storage medium. Alternatively, other formats for the compression are also possible. Belonging to these are MPEG-4 AAC, Dolby AC3, Lucent PAC, Liquid Audio, ATRAC and Real Audio.

Furthermore, it is advantageous that the input apparatus of the device according to the present invention is designed as a remote control which is then advantageously placed on the steering wheel, thus simplifying the operation of the device according to the present invention.

Another advantage is that information is pushed step-by-step across the display in the event the information is not displayable on the given display in one step. Consequently, the display is also able to display long pieces of information.

### BRIEF DESCRIPTION OF THE DRAWINGS

FIG. 1 shows a block diagram of the device according to the present invention.

FIG. 2 shows a directory tree of the audio data files stored on the storage device.

### DETAILED DESCRIPTION

Multimedia data files that are highly compressed in particular with the aid of MP3 coding in the case of audio data, or of the future MPEG-4 AAC (Advanced Audio Coding), are so small that a great number of individual titles fit on one storage device. If such MP3 audio data files are played back by an automotive sound system, then an intuitive operating concept is desirable, since the driver cannot concern himself intensively with the operation because he must concentrate on his driving. Furthermore, an automotive sound system generally has only one small display, preferably a single-line display. If multimedia data files are present which also have video information, then a larger display is used for the playback. Hereinbelow, the term multimedia data file also includes the term audio data file.

Therefore, according to the present invention, a device for playing back multimedia data files from a storage device in an automotive sound system has a processor which permits directories on a storage device—in which directories such MP3 audio data files or other coded multimedia data files are located—to be interpreted and displayed as data carriers, and the individual multimedia data files as different titles. The different data carriers and different titles are selected with the aid of the input apparatus of the device according to the present invention. A rocker, which is operable both in the horizontal and in the vertical direction, is used for selecting the data carriers and the titles. Stipulation of a time for the display of a data carrier and the automatic switch-over to the first title of a data carrier and the automatic start of play of a title ensure that operation is made considerably easier for the driver in order to play back pieces of music, possibly with video clips.

Furthermore, after the insertion of a new storage device into the disk drive, the first multimedia data file with the first title on the first data carrier is automatically decoded and played back with the aid of the loudspeaker. Thus, a driver only has to insert one storage medium, and music is then started to be played back immediately. Other possibilities which are known from CDs or minidisk disk drives in automotive sound systems, such as a random playback—a MIX function—of various titles on one storage device or one data carrier, are possible here, as well.

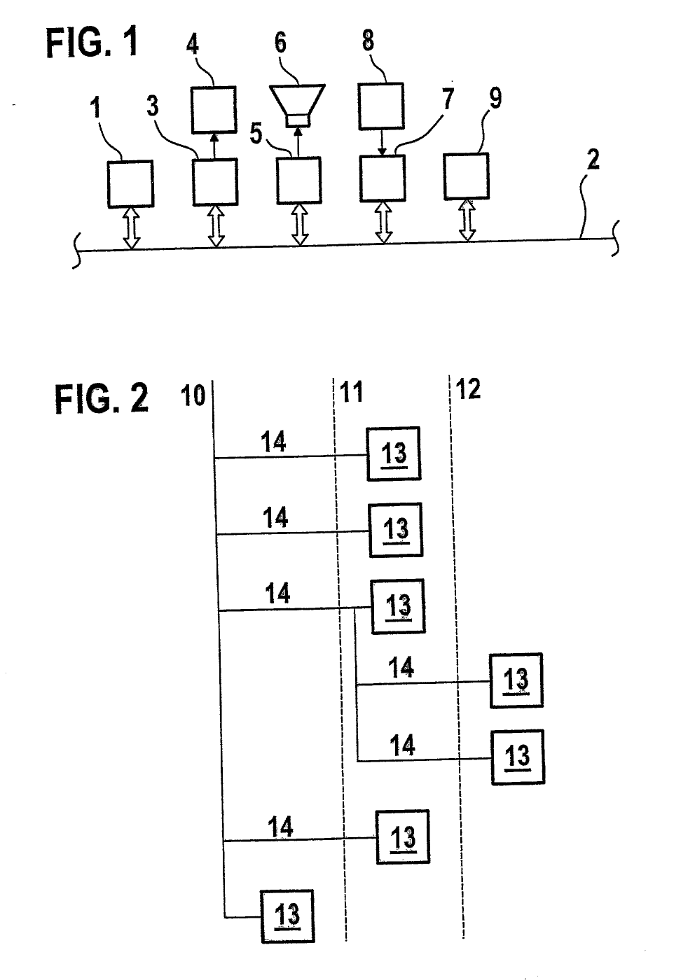

FIG. 1 shows a block diagram of the device according to the present invention for playing back multimedia data files from a storage device in an automotive sound system. The individual components of the device according to the present invention are interconnected via a bus 2. Here, bus 2 is an electrical line system, however, an optical line system or a radio-based bus is also possible. If an optical bus system is provided, then the individual components linked to the bus have optocouplers in order to receive signals from the bus and to send signals via the bus. If a radio-based bus is used, then the bus stations linked to the bus have a transceiver station. Here, the components linked to bus 2 have a bus controller which controls the transmission via bus 2.

A processor 1, signal processing elements 3, 5 and 7, and the storage device with a disk drive 9 are connected to bus 2 via data inputs/outputs. A display 4 is connected to signal processing element 3. A loudspeaker 6 is connected to signal processing element 5 via a data output. An input apparatus 8 is connected to a data input of signal processing element 7. Further components are connectible to bus 2. Direct wiring of the components is possible as an alternative to bus 2. Which type of connection is the more favorable is decided depending on the number of components to be connected. When working with a small number of components, direct wiring can be a sensible alternative. The components listed are located either in the housing of the automotive sound system, or are at least connected to the automotive sound system.

Processor 1 receives signals from input apparatus 8, the signals from input apparatus 8 being prepared by signal processing element 7 for transmission via bus 2 to processor 1. Depending on these input signals, processor 1 performs an action, e.g. the decoding of audio data files or multimedia data files located in storage device 9. If a storage device is inserted into disk drive 9, here a CD ROM as data carrier, then processor 1 reads the directory structure of the CD ROM and displays this directory structure, in converted form and either in parts or totally, on display 4.

Also connectible to bus 2 is a receiving station which receives broadcast programs. In this case, processor 1 will also decode the audio data of the broadcast programs, since it is possible to listen to either stored audio data files or a broadcast program. If digital broadcast programs are transmitted, then DAB (Digital Audio Broadcasting) is a suitable method for transmitting them. DRM (Digital Radio Mondial) and DVB (Digital Video Broadcasting) are also usable for this purpose. Processor 1 has software to decode the audio data transmitted with these methods, as well. The transmission of multimedia data files is also possible with the aid of these digital transmission methods.

FIG. 2 shows such a directory structure as a directory tree. Located in a main plane 10 are directories 14 and a group of audio data files 13. In a plane 11 below main plane 10, audio data files 13 in each case adjoin the first two directories. A group of audio data files 13 and two further directories 14 likewise adjoin the third directory. A group 13 of audio data files in plane 11 also adjoins the last directory of main plane 10. The two directories in plane 11 lead below it to plane 12, a group of audio data files 13 following the two respective directories 14. At this point, processor 1 interprets directories 14 as different data carriers. Modeled on the use of the widespread CD changer for automotive sound systems, the individual directories are interpreted as CD 1, CD 2, CD 3, etc. The groups of audio data files 13 are in each case represented as titles for the corresponding directory. In this context, processor 1 evaluates the title contained in the respective audio data file, and displays it on display 4, or, if the title is not available, processor 1 alternatively displays the name of the audio data file or a number, thus a track number, on display 4. If titles or other information that processor 1 is to display on display 4 are longer than display 4 is able to display all at once, then this information is pushed step-by-step across display 4 in a scrolling process.

Input apparatus 8 has a rocker which is operable both in the horizontal and in the vertical direction. Here, the horizontal actuation of the rocker leads to a selection from among the individual directories, thus from among the individual CDs and therefore from among the individual data carriers. Directories 14 are thus interpreted as data carriers. On the other hand, the audio data files are interpreted as individual titles. If at this point, the rocker is used to select a CD, e.g. CD 2, as the second directory, the user stops actuating the rocker when CD 2 appears on display 4. With the vertical operation of the rocker, the user is now able to select the individual titles from CD 2, e.g. titles 1 through 10. If the user fails to make this selection, then after a first predefined time, e.g. five seconds, the first title of CD 2 is automatically displayed on display 4, and then this title, and indeed the corresponding audio data file, is played back. If the user selects a title from CD 2, then this title is briefly displayed for a predefined time and then played back.

If directories and therefore data carriers, thus, in this case, CDs, are present in different planes, here main plane 10 and plane 11, then the directories as data carriers are numbered consecutively CD 1 through CD 6 by processor 1, and are selectable using the horizontal movement of the rocker, that is to say, the actual tree structure plays no role for the utilization; the user only selects from among the data carriers. In this context, the data carriers can either be numbered consecutively according to the planes, or the directories in the subsequent planes can be integrated directly.

If an audio data file is now played back, then processor 1 decodes the coded audio data file. Here, the audio data files are coded using MP3. MP3 is a source coding, redundancy and irrelevancy being removed from the audio data with the aid of a psycho-acoustic model, in order to then obtain a signal during the decoding which cannot be differentiated from the original in the listening impression. In this manner, only the essential information of the music is stored. However, any other audio coding method can also be used here. The decoded data are then transmitted by processor 1 to signal processing element 5 which converts the decoded data into analog signals, and supplies them to an audio amplifier, in order then to transmit these audio signals to loudspeaker 6 which then reproduces the audio signals as acoustic signals. Here, loudspeaker 6 represents one loudspeaker, but it can also be a complete loudspeaker system.

If a user inserts a storage device into disk drive 9, then the first title of the first data carrier, in this case CD 1 which is thus the first directory, is displayed on display 4, and after a predefined time, the audio data file belonging to this title is played back. In a further development, it is possible for all subsequent titles to then be directly played back, so that the driver is free from any operating process. This can be carried out to the extent that all data carriers with all titles are subsequently played through, until the user undertakes an input process using input apparatus 8.

In addition, input apparatus 8 has an element for the input for additional functions. Belonging to such additional functions is the so-called MIX, which is the random playback of all titles on a sound-recording medium, thus, in this case, on a CD as data carrier. In this context, the user selects a directory 14, thus a data carrier and here a CD, and titles 13 for this CD are played back in random sequence. To that end, processor 1 accesses a memory belonging to it in order to determine a random number and consequently a random sequence. So many random numbers are stored in this memory that the random sequence is only repeated after the MIX function has been actuated a great number of times. The MIX function can also be supplemented by the MIX All function, the result of which is that all the titles of all the data carriers on the storage device located in disk drive 9 are played back in random sequence. The operation of the MIX and MIX All functions and other functions of the automotive sound system is possible either by soft keys or by labeled keys provided especially for this purpose. The soft keys allow the existing keys to be repeatedly allocated depending on a set menu. Consequently, a large part of the manual operation is shifted into the software.

Moreover, the device of the present invention has the function that so-called play lists are created. For such play lists, the user utilizes input apparatus 8 to select audio data files which are stored in the storage device and links these audio data files to a new directory, the device generating a name, e.g. play list 1, in order to then consecutively number the play lists accordingly. Using further inputs, the user can sort the audio data files, either automatically or manually, according to various criteria. Audio data files can be deleted from the new directory by further inputs.

The creation of a play list looks in detail as follows. First of all, the title, and consequently the audio data file, which is intended in the play list is selected. A TPM (Track Program Memory) key is then pressed in order to store the title in the new play list. A play list can be selected with station keys. If a plurality is available, the user is free to select one play list. The storage of the title in the new play list is confirmed by a tone reproduced through loudspeaker 6. This can also be done by display 4 lighting up, or an appropriate message presented on display 4. The play lists are stored in a memory in the automotive sound system or on an interchangeable storage medium which can also be the storage device in disk drive 9. In this connection, only references to the audio data files of the play lists are stored; the audio data files themselves can also be copied alternatively into the play list.

The play lists and the titles therein are selected analogously to the manner described above, it also being possible to use the MIX function. A title can be moved in a play list by so-called cut and insert keys. A title is deleted by highlighting it until a tone is reproduced through loudspeaker 6. The keys listed here are implemented either as soft keys or as separate keys on the automotive sound system.

Here, a CD ROM is used as the storage device which is inserted into disk drive 9. However, a DVD, a minidisk, a hard disk or a chip card are also possible. Alternatively, it is also possible for the storage device to be permanently installed in the automotive sound system, data then being copied to the hard disk via wireless or wire-bound interfaces. Furthermore, it is possible to provide a permanently installed memory in addition to disk drive 9 for interchangeable storage devices. The permanently installed memory can be a hard disk, a solid-state memory, an optical memory or a magneto-optical memory. If the database on the permanently installed memory is so large that a very large number of music selections can be stored, then a non-rewritable memory can be used, and the user, for example, selects his favorites with the aid of the play lists.

Signal processing element 3 prepares the signals provided for display on display 4, and controls display 4 accordingly. Here, display 4 is designed as a TFT (Thin Film Transistor) display. Belonging to such signals are the title of the audio or multimedia data file, other text information, or video clips in the case of multimedia data files.

Input apparatus 8 can alternatively be designed as a remote control which communicates with the device of the present invention via an infrared or radio link. To that end, the remote control has a transmitting device by which signals are sent from the remote control. In the case of infrared, it is a light-emitting diode; in the case of radio, it is a transmitter with antenna. The device of the present invention has for this purpose a receiver, in the infrared a photodiode, and in the case of radio, a receiver with antenna.

What is claimed is:

1. A device for playing back multimedia data files stored in an automotive sound system, comprising:
a display;
a loudspeaker for performing a playback of the multimedia data files;
an input apparatus;
a storage device; and
a processor for decoding the multimedia data files, wherein:
the processor includes an element for displaying directories located in the storage device and in which the multimedia data files are contained, as different data carriers, and the multimedia data files as different titles on the display, and
the different data carriers and the different titles are selectable in accordance with an operation of the input apparatus.

2. The device according to claim 1, wherein:
the processor, together with the operation of the input apparatus, is capable of linking the multimedia data files, located on the storage device, to at least one new directory, and
the processor provides an option to store the multimedia data files once again.

3. The device according to claim 2, wherein:
the input apparatus includes a plurality of operating control elements that permits a management of the at least one new directory.

4. The device according to claim 1, wherein:
the input apparatus includes a rocker that is operable both in a vertical direction and in a horizontal direction.

5. The device according to claim 1, wherein:
after one of the different data carriers is selected, the processor displays the selected one of the different data carriers on the display for a first predefined time,
after the first predefined time, the processor displays a first one of the different titles of the selected one of the different data carriers on the display, and
the processor, in accordance with an operation of the loudspeaker, plays back the multimedia data file corresponding to the first one of the different titles.

6. The device according to claim 1, further comprising:
a disk drive for the storage device, wherein:
the storage device is removable from the disk drive.

7. The device according to claim 6, wherein after the storage device is inserted into the disk drive, the processor:
automatically decodes a first one of the multimedia data files having a first one of the different titles in a first one of the different data carriers, and
plays back through the loudspeaker.

8. The device according to claim 1, wherein:
the processor extracts information from respective ones of the multimedia data files, and
the processor provides the extracted information to the display.

9. The device according to claim 8, wherein:
when a respective one of the multimedia data files does not store a corresponding one of the different titles, the processor displays one of a name of the respective one of the multimedia data file and a number as title on the display.

10. The device according to claim 1, wherein:
after an input signal is provided by the input apparatus, the processor plays back the multimedia data files of one of the different data carriers in a random sequence.

11. The device according to claim 1, wherein:
after an input signal is provided by the input apparatus, the processor plays back all the multimedia data files of the storage device in a random sequence.

12. The device according to claim 1, wherein:
after an input signal is provided by the input apparatus, the processor begins to play the multimedia data files of one of the different data carriers and of the entire storage device.

13. The device according to claim 1, wherein:
the storage device includes one of a CD ROM, a DVD, a minidisk, a chip card, and a hard disk.

14. The device according to claim 1, wherein:
the multimedia data files are coded in MP3.

15. The device according to claim 1, wherein:
the input apparatus includes a remote control apparatus.

16. The device according to claim 1, wherein:
the processor displays information step-by-step on the display.
